(19) United States
(12) Patent Application Publication
(10) Pub. No.: US 2025/0238931 A1
(43) Pub. Date: Jul. 24, 2025

(54) IMAGE PROCESSING APPARATUS AND METHOD, AND STORAGE MEDIUM

(71) Applicant: CANON KABUSHIKI KAISHA, Tokyo (JP)

(72) Inventor: Atsushi GOTO, Kanagawa (JP)

(21) Appl. No.: 19/175,327

(22) Filed: Apr. 10, 2025

Related U.S. Application Data
(63) Continuation of application No. PCT/JP2023/035348, filed on Sep. 28, 2023.

(30) Foreign Application Priority Data
Oct. 31, 2022 (JP) 2022-175027

(51) Int. Cl. G06T 7/11; G06T 3/40; G06T 7/62; G06V 10/25; G06V 10/60; G06V 10/762; G06V 20/70

(52) U.S. Cl. CPC G06T 7/11; G06T 3/40; G06T 7/62; G06V 10/25; G06V 10/60; G06V 10/762; G06V 20/70

(57) ABSTRACT

An image processing apparatus comprises one or more processors and/or circuitry which function as: an input unit that inputs image data of an image; an acquisition unit that acquires a size of an object region including an object to be extracted that is included in the image; a setting unit that sets a division number into which the object region is divided; a determination unit that determines a segment size of a superpixel based on the size of the object region and the division number; and a generation unit that generates, using the image data, superpixels each having a size in a predetermined range that includes the segment size determined by the determination unit.

### CROSS-REFERENCE TO RELATED APPLICATIONS

This application is a Continuation of International Patent Application No. PCT/JP2023/035348, filed Sep. 28, 2023, which claims the benefit of Japanese Patent Application No. 2022-175027, filed Oct. 31, 2022, both of which are hereby incorporated by reference herein in their entirety.

### BACKGROUND OF THE INVENTION

### Field of the Invention

The present invention relates to an image processing apparatus and method, and a storage medium, and more particularly to an image segmentation technique.

### Background Art

Conventionally, semantic segmentation is known in machine learning. Semantic segmentation is a task of dividing an image into a plurality of regions of objects. To perform semantic segmentation, the image is detailed pixel by pixel and output. At this time, the training data for semantic segmentation needs to be labeled for each pixel.

Therefore, in semantic segmentation, the annotation work (the work of labeling images and creating training data) is very burdensome, so to reduce the workload, superpixels are used. A superpixel is a small region formed by grouping pixels with similar colors and/or textures.

For example, PTL 1 discloses a method for segmenting an image using hybrid-scale superpixels. Specifically, a user replaces larger-scale superpixels in a region of interest (Region of Interest: ROI) with smaller-scale superpixels (region size of the superpixel) to improve segmentation, thereby achieving better boundary depiction.

Further, PTL 2 discloses a region discrimination apparatus that discriminates regions based on a saliency map and superpixels.

### CITATION LIST

### Patent Literature

PTL1: Japanese Patent Laid-Open No. 2018-514024
PTL2: Japanese Patent Laid-Open No. 2019-61658

However, according to the technique described in PTL 1, when superpixels in an ROI are replaced with superpixels of a smaller scale, the scale is based on a user's instruction, and therefore a good segmentation boundary may not be always obtained. That is, if the scale is too large, the boundary accuracy deteriorates, and if the scale is too small, the workload of selecting superpixels when segmenting an image increases.

In addition, in PTL 2, the scale of the superpixels is not changed. Therefore, if an object having a size different from an expected size or a plurality of objects with different sizes exist in the same image, it is not possible to generate superpixels of an appropriate scale, and it is not possible to attain the segmentation boundary with good accuracy.

The present invention has been made in consideration of the above problems, and aims to strike a balance between improvement of boundary accuracy using superpixels and reduction of the load of segmentation work when segmenting an image in annotation work.

### SUMMARY OF THE INVENTION

According to the present invention, provided is an image processing apparatus comprising one or more processors and/or circuitry which function as: an input unit that inputs image data of an image; an acquisition unit that acquires a size of an object region including an object to be extracted that is included in the image; a setting unit that sets a division number into which the object region is divided; a determination unit that determines a segment size of a superpixel based on the size of the object region and the division number; and a generation unit that generates, using the image data, superpixels each having a size in a predetermined range that includes the segment size determined by the determination unit.

Further, according to the present invention, provided is an image processing method comprising: inputting image data of an image; acquiring a size of an object region including an object to be extracted that is included in the image; setting a division number into which the object region is divided; determining a segment size of a superpixel based on the size of the object region and the division number; and generating, using the image data, superpixels each having a size in a predetermined range that includes the determined segment size.

Furthermore, according to the present invention, provided is a non-transitory computer-readable storage medium, the storage medium storing a program that is executable by the computer, wherein the program includes program code for causing the computer to function as an image processing apparatus comprising: an input unit that inputs image data of an image; an acquisition unit that acquires a size of an object region including an object to be extracted that is included in the image; a setting unit that sets a division number into which the object region is divided; a determination unit that determines a segment size of a superpixel based on the size of the object region and the division number; and a generation unit that generates, using the image data, superpixels each having a size in a predetermined range that includes the segment size determined by the determination unit.

Further features of the present invention will become apparent from the following description of exemplary embodiments with reference to the attached drawings.

### BRIEF DESCRIPTION OF THE DRAWINGS

FIG. 1 is a block diagram illustrating a functional configuration of an image processing system according to first and second embodiments of the present invention.

FIG. 2 is a diagram illustrating an example of a hardware configuration of the image processing system according to an embodiment.

FIG. 3 is a diagram illustrating an example of an input image to be analyzed according to the first embodiment.

FIG. 4 is a flowchart illustrating an operation of the image processing system according to the first embodiment.

FIG. 5 is an explanatory diagram relating to the designation of a region of a target object according to the first embodiment.

FIG. 6 is a diagram illustrating an example of a GUI of application software according to the first embodiment.

FIG. 7 is a diagram illustrating an example of an intermediate image in segmentation processing according to the first embodiment.

FIG. 8 is a diagram illustrating an example of a portion of a GUI of application software according to the second embodiment.

FIG. 9 is a block diagram illustrating a functional configuration of an image processing system according to a third embodiment.

FIG. 10 is a flowchart illustrating an operation of the image processing system according to the third embodiment.

FIG. 11 is a block diagram illustrating a functional configuration of an image processing system according to a fourth embodiment.

FIG. 12 is a flowchart illustrating an operation of an image processing system according to the fourth embodiment.

FIG. 13 is an enlarged partial view illustrating an example of an input image according to the fourth embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

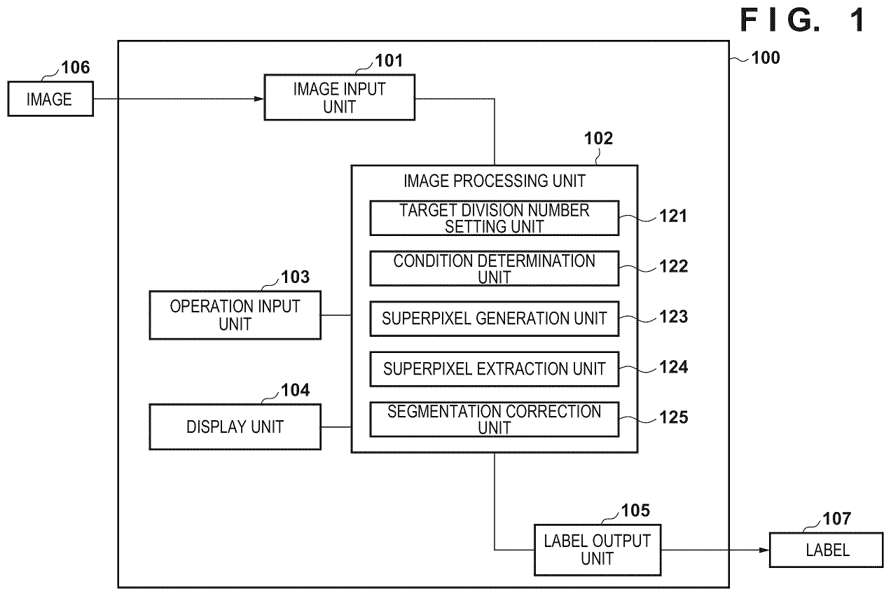

FIG. 1 is a block diagram illustrating a functional configuration of an image processing system 100 according to a first embodiment of the present invention. As shown in FIG. 1, the image processing system 100 has an image input unit 101, an image processing unit 102, an operation input unit 103, a display unit 104, and a label output unit 105.

The image input unit 101 inputs an image 106 (image data) to be analyzed to the image processing system 100, and the image processing unit 102 executes application software to perform segmentation processing on the image 106 input to the image input unit 101. The operation input unit 103 is composed of a mouse, keyboard, tablet, etc., and an operator operates the operation input unit 103 to input information to the image processing unit 102. The display unit 104 interactively displays the image being processed by the image processing unit 102 and the operation results of the operation input unit 103, etc. The label output unit 105 outputs a segmentation result, which is the processing result of the image processing unit 102, as a label 107. The output label 107 is stored in a storage device (not shown).

Next, a functional configuration of the image processing unit 102 will be described.

When dividing the image 106 into superpixels, a target division number setting unit 121 sets the number of superpixels into which a target object in the image that is to be segmented (extracted) is to be divided (target division number). A condition determination unit 122 determines superpixel generation conditions based on the size of the region of the target object (object region) and the set target division number. Here, the average segment size (average scale) of the superpixels is calculated as the superpixel generation condition. A superpixel generation unit 123 generates superpixels based on the average segment size.

A superpixel extraction unit 124 performs segmentation using superpixels corresponding to a target object selected by a GUI tool of the application software using the operation input unit 103. A segmentation correction unit 125 corrects errors in the segmentation results by the superpixel extraction unit 124. Specifically, among the superpixels selected by segmentation, a region of a superpixel that protrudes from the target object or a region of a missing or insufficient superpixel is corrected pixel by pixel using a pen tool or the like to bring the region closer to the region of the target object.

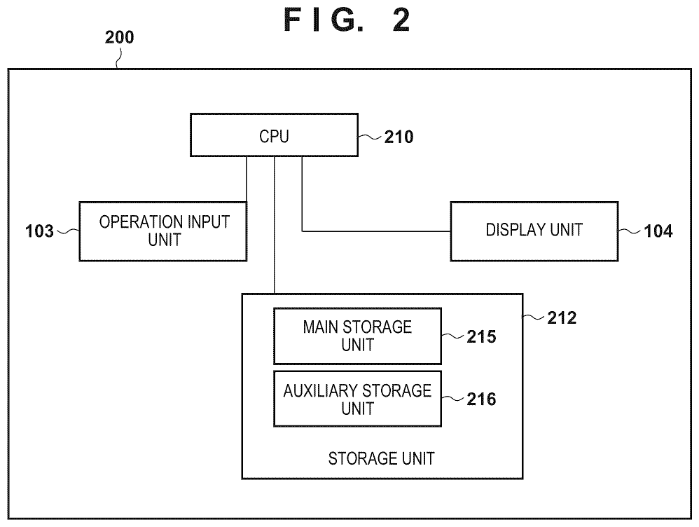

FIG. 2 is a block diagram illustrating a configuration of a computer 200 as an example of a hardware configuration of the image processing system 100. Each function of the image processing system 100 can be realized by the computer 200. The computer 200 includes a central processing unit (CPU) 210, a storage unit 212, the operation input unit 103 (e.g., a mouse, a keyboard, etc.), and the display unit 104 (a display, etc.) shown in FIG. 2.

The storage unit 212 is composed of a main storage unit 215 (ROM or RAM, etc.) and an auxiliary storage unit 216 (magnetic disk device, SSD: Solid State Drive, etc.).

The CPU 210 performs calculations and control, and executes programs stored in the storage unit 212, thereby functioning as the image processing unit 102 of the image processing system 100 shown in FIG. 1.

The computer 200 may include one or more CPUs 210 and storage units 212. That is, if at least one or more processing devices (CPUs) are connected to at least one storage device, and if the at least one or more processing devices execute a program stored in at least one or more storage devices, the computer 200 functions as the image processing unit 102. The configuration that functions as the image processing unit 102 is not limited to the CPU 210, and may be a FPGA (Field Programmable Gate Array) or an ASIC (Application Specific Integration Circuit), etc.

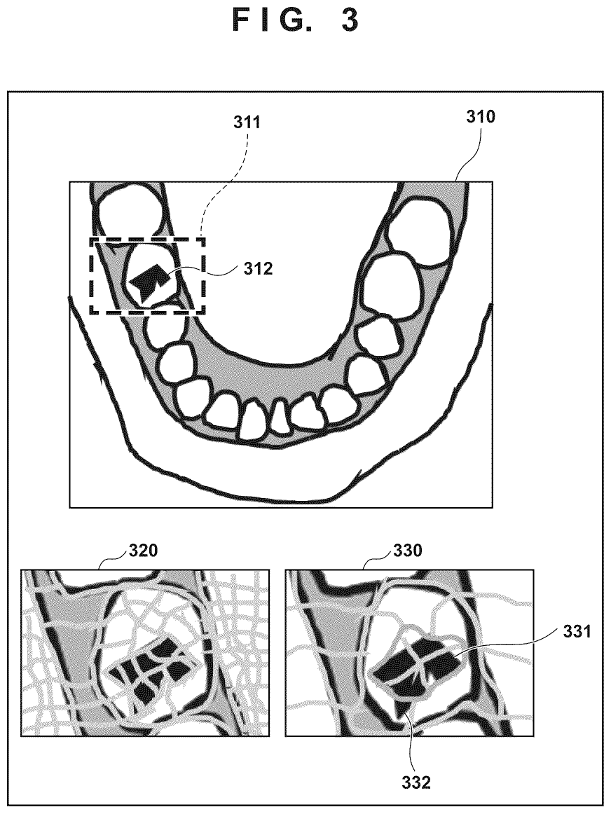

Next, details of the target division number setting unit 121 in this embodiment will be described with reference to FIG. 3 which shows an example of an image to be analyzed. In this embodiment, the image to be analyzed is a dental image, and a dental restoration is the target object of segmentation, but the types of images to be analyzed and target objects are not limited to this.

In an image 310, an object 312 is a dental restoration, which is the target object of segmentation.

The superpixel generation unit 123 executes superpixel processing on the entire image to be analyzed. Images 320 and 330 are enlarged images of a region 311 around a target object in an image in which the result of the superpixel processing is superimposed on an input image. In the superpixel processing, an average segment size, which is a setting value indicating the size of the superpixels with which the image is divided, is set. The image 320 is an example in which the average segment size is small, and the image 330 is an example in which the average segment size is large.

The larger the average segment size, the larger the size of each superpixel, and the lighter the extraction load on the superpixel extraction unit 124. On the other hand, as shown in the image 330, the more likely it is that superpixels will protrude from the target object as a protrude portion 331, or that part of the target object will not be included in the superpixels as a missing or insufficient portion 332, resulting in lower segmentation accuracy.

By contrast, the smaller the average segment size, the smaller the size of each superpixel, which increases the extraction workload on the superpixel extraction unit 124, but the higher the segmentation accuracy for the target object, as can be seen in the image 320.

Thus, there is a trade-off between the workload of superpixel extraction and segmentation accuracy.

The target division number setting unit 121 sets how many superpixels the target object, i.e., in this embodiment, the restoration in the dental image, is to be divided into (the target division number). For example, in the example of image 320 of FIG. 3, the restoration 312 is divided into about 9 superpixels, and the target division number is 9. On the other hand, in the example of image 330, the restoration 312 is divided into about 4 superpixels, and the target division number is 4.

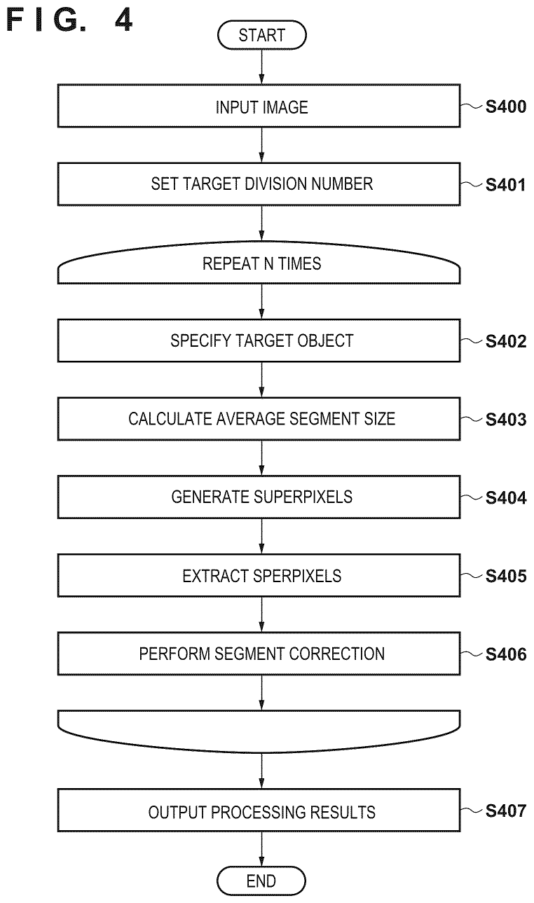

Next, an operation of the image processing system 100 in the first embodiment will be described with reference to the flowchart shown in FIG. 4.

First, in step S400, the CPU 210 inputs an image to be analyzed via the image input unit 101.

In step S401, the CPU 210 sets a target division number in the image processing unit 102 by the target division number setting unit 121 through the operator operating the operation input unit 103. As described above, there is a trade-off between the workload of superpixel extraction and the segmentation accuracy. The operator sets a target division number that does not impose a large workload of superpixel extraction and provides sufficient segmentation accuracy. In many cases, a balance between the workload and the segmentation accuracy can be struck by setting the target division number between 10 and 100. In this embodiment, the target division number is described as 50 as an example, but is not limited to this value. In a case where the target division number is set to 50, the operator selects approximately 50 superpixels that constitute the target object.

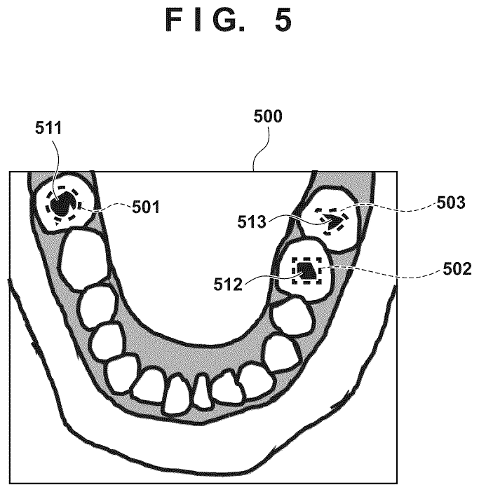

In step S402, the CPU 210 specifies a target object by the condition determination unit 122 based on the operator's operation of the operation input unit 103. FIG. 5 shows an explanatory diagram relating to the specification of target objects according to the first embodiment.

As an example, an input image 500 to be analyzed is a dental image, and target objects 511, 512, and 513 are dental restorations. Specifying a region of a target object is to roughly surround a target object with a closed curve. As an example, the region of the target object 511 may be specified by a circle 501 using a circle drawing tool, and as another example, the region of the target object 512 may be specified by a rectangle 502 using a rectangle drawing tool. As yet another example, the region of the target object 513 may be specified by a closed curve 503 using a freehand tool. When the freehand tool is used, the rough shape of the target object 513 can be obtained.

As the CPU 210 specifies a target object by the method described above or the like, it obtains the number of pixels (size) of the region within the drawn closed curve as the approximate target size.

Given that the target objects have the same size, the more complex the shape of the target object, the lower the segmentation accuracy by superpixels. Therefore, the value of the target division number set in step S401 may be corrected based on the complexity of the shape of the target object obtained by using the freehand tool. The complexity is calculated using curvature entropy, circularity, etc., and the larger this value is, the more the value of the target division number is corrected. In this way, it is possible to improve the accuracy of segmentation by superpixels by taking into account the shape of the target object. Note that a default value may be set in step S401 as the target division number, and the target division number may be re-determined in step S402 based on the obtained shape of the target object.

As another example, deep learning may be used to perform object detection of teeth and dental diseases, and the region of the target object may be specified by selecting one of the rectangular detection results obtained.

In step S403, an average segment size is calculated. Here, the CPU 210 obtains an approximate number of pixels (size) of the region of the target object from the closed curve surrounding the target object specified in step S402 by the condition determination unit 122, and divides it by the target division number. In this way, the average segment size of the superpixel is calculated.

In step S404, superpixels are generated. Here, the CPU 210 uses the superpixel generation unit 123 to execute a superpixel processing on the image to be analyzed using the average segment size calculated in step S403. In this embodiment, LSC (Linear Spectral Clustering) is used as the superpixel algorithm.

It should be noted that other algorithms may be used, such as SEEDS (Superpixel Extracted via Energy-Driven Sampling) or SLIC (Simple Linear Iterative Clustering). Depending on the implementation, the size of the image to be analyzed may be divided by the average segment size to obtain the number of superpixels in the entire image, which may then be used as input for the superpixel processing.

Furthermore, the segment size of each superpixel may be within a predetermined range including the average segment size calculated in step S403.

In step S405, superpixels corresponding to the target object are extracted. Here, the CPU 210 uses the superpixel extraction unit 124 to extract superpixels corresponding to the target object based on the operator's work. In this process, the CPU 210 displays a GUI of the application software on the display unit 104, displays the input image on the GUI, and superimposes a layer of the segment map of the generated superpixels on the input image. Then, at a position on the image to be analyzed designated by the mouse or through a tablet, the superpixel corresponding to that position is displayed, and an region corresponding to the target object is extracted in units of superpixels.

In step S406, segment correction is performed. Here, the CPU 210 uses the segmentation correction unit 125 to correct the region extracted in step S405 based on the operator's work. Specifically, in the region extracted in units of superpixels, portions that are protruding from the target object, or portions of the object that are not included in the superpixels are corrected in units of pixel. An eraser tool, pen tool, or the like is used for the correction.

If there are N types of approximate target sizes of target objects to be segmented in the input image, the above-mentioned processes from step S402 to step S406 are performed N times for each approximate target size. In other words, if there are a plurality of target objects in the input image, the same superpixel processing is performed for target objects having approximately the same approximate target size, and for target objects of different sizes, the regions of the target objects are redesignated, the conditions for the superpixel processing are changed, and the superpixel processing is performed in different cycles.

The types of approximate target sizes can be classified using a plurality of thresholds. Further, as described above, in a case where the region of the target object is specified by a predetermined shape such as a circle or a rectangle, circles and rectangles of a plurality of sizes may be prepared in advance, and the approximate target size may be classified by using a circle or rectangle of an appropriate size from among them.

In step S407, the processing results are output. Here, the segment map corrected in step S406 is output in association with the input image and saved as a label. The label is saved in IndexPNG format (also known as palette format), which is often used as training data for semantic segmentation.

The format of the label may be bitmap format or another format, and can be selected according to the application of the label.

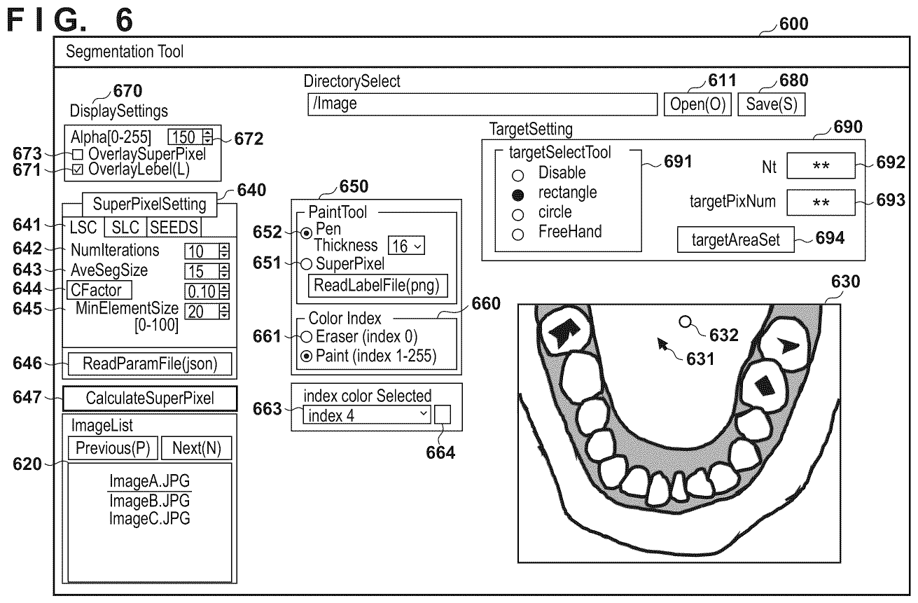

Next, FIG. 6 shows an example of a GUI (Graphical User Interface) of the application software in this embodiment.

A GUI 600 of the application software is displayed on the display unit 104, and has various control areas for achieving segmentation using superpixels.

By pressing “Open” button 611, the directory of the image to be segmented can be selected.

“ImageList” 620 displays a list of images registered in the directory, and a selected image from among them is displayed in a picture box 630. In the picture box 630, a pointer 631 or a circular pointer 632 that can be controlled by the operation input unit 103 is displayed.

In “TargetSetting” 690, various tools used in specifying the region of the target object in step S402 are arranged. In “targetSelect” 691, which is a group of radio buttons, tools for specifying a closed curve for roughly specifying the region of a target object are arranged. In this embodiment, as an example, “rectangle” for specifying a rectangular region, “circle” for specifying a circular region, “FreeHand” for specifying a free region, and “Disable” are arranged. When “Disable” is selected, the rough specification of the region of a target object is disabled, and when a radio button other than “Disable” is selected, the rough specification of the region of a target object is enabled.

After obtaining a closed curve, the size of the region specified by the closed curve is displayed in “targetPixNum” 693.

“Nt” 692 is an area for inputting the target division number in step S401. Then, by pressing “targetAreaSet” 694, the average segment size calculated from the size of the region specified by the closed curve and the target division number is displayed in “AveSegSize” 643.

In “SuperPixelSetting” 640, input boxes for setting values of superpixel processing conditions are arranged. Using a superpixel algorithm selection tab 641, a superpixel algorithm can be selected. In the example of FIG. 6, LSC is selected as the superpixel algorithm. In addition, in the LSC algorithm tab, “NumIterations” 642, which is a setting value of the number of iterations used in the clustering phase of the algorithm, “AveSegSize” (Average Segment Size) 643, which is a setting value of the square root of the average segment size (number of pixels) of superpixels, “CFactor” (Compactness Factor) 644, which is a setting value related to the shape of superpixels, and “MinElementSize” (Minimum Element Size) 645, which is a setting value of the minimum superpixel segment size, are arranged.

“CFactor” 644 controls the shape of a superpixel; the higher the value, the more regular the shape of the superpixel.

“MinElementSize” 645 represents the minimum segment size of a superpixel; a superpixels smaller than this size is absorbed into a larger superpixel. Changing “MinElementSize” setting affects the number of superpixel divisions, so the average segment size obtained in step S403 is calculated taking this effect into account.

Note that these specific settings are merely examples and can be changed to suit the characteristics of the image to be segmented.

Since “SuperPixelSetting” 640 includes a plurality of setting items, each setting value can be recorded in a json file and then selected using the “ReadParamFile” 646 button or the like to read them all at once.

Then, by pressing “CalculateSuperPixel” button 647, the superpixel processing is performed on the image selected and displayed in the picture box 630.

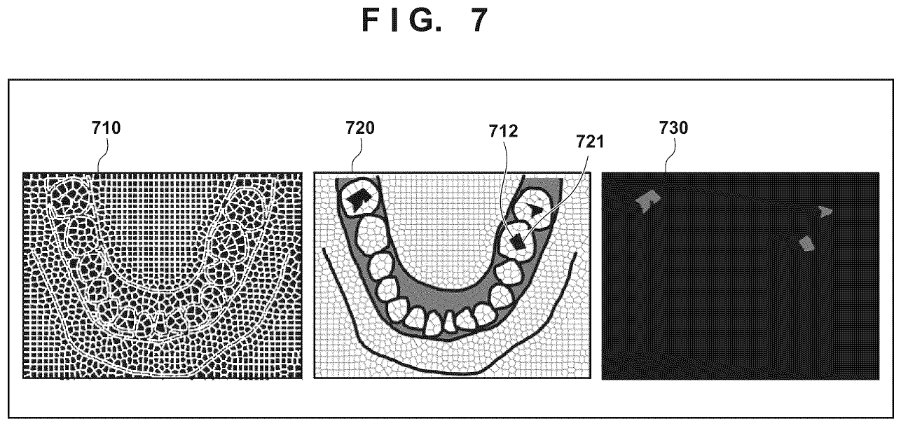

FIG. 7 shows an example of an intermediate image in the segmentation processing.

An image 710 shows the result of the superpixel processing. An image 720 shows the input image on which a superpixel segment map is superimposed. The selected superpixels and corrected portion 721 are superimposed on a restoration 712. The corrected portion 721 is superimposed and displayed in a color corresponding to the selected index. An image 730 is an image in which the superpixels selected by the user in the image 720 and the correction result are output as labels.

When “CalculateSuperPixel” button 647 is pressed, the image 720 is displayed in the picture box 630.

In “PaintTool” 650 in FIG. 6, various tools (controls) used in the superpixel extraction process in step S405 and the segment correction process in step S406 are arranged.

“SuperPixel” 651 is a tool used in the superpixel extraction process in step S405; by clicking in the picture box 630 using a mouse, tablet, etc., a superpixel corresponding to the designated coordinates is extracted and the corresponding superpixel is superimposed and displayed. An example of the superimposed display is the image 720 in FIG. 7.

“Pen” 652 is a tool used in the segment correction process in step S406; by dragging in the picture box 630 using a mouse, tablet, etc., a region corresponding to the specified coordinates is extracted by freehand. Note that “PaintTool” is not limited to “Pen” 652 and “SuperPixel” 651, but may be a filling tool that fills in closed areas, or a tool for drawing shapes such as rectangles, circles, and triangles.

“ColorIndex” 660 is an area for specifying the index used when labeling in the superpixel extraction in step S405 and the segment correction in step S406.

“Eraser” 661 labels with Index 0. In this embodiment, Index 0 indicates a background label, and “Eraser” 661 is a so-called eraser tool.

When a color index is specified in a combo box 663, the color in a palette corresponding to that index is displayed in an area 664. Note that “Index” can be set to a value between 0 and 255, and for example, PascalVOC2012 may be the index value of the color map corresponding to the dataset.

“DisplaySettings” 670 includes an area where the display of labels and super pixels can be turned ON/OFF to facilitate labeling in the superpixel extraction process in step S405 and the segment correction process in step S406.

When the check box of “OverlayLabel” 671 is OFF, the label is not displayed in the picture box, and when it is ON, the label is displayed in the picture box with the transparency specified in the numerical value setting box 672. This makes it possible to work while checking whether the labeling is successful. When the check box “OverlaySuperpixel” 673 is ON, the superpixels are displayed, and when it is OFF, the superpixels are not displayed.

“Save” button 680 converts the label, which is the processing results generated in the picture box 630, into a predetermined format in the output in step S407 and saves it.

These processes may be performed by resizing (reducing) the input image to a smaller size, and then resizing the output label to the original size. The resizing algorithm may use, for example, the nearest neighbors method, and after resizing, the boundaries may be smoothed by performing “Erosion” and “Dilation” processes, which are enlargement and reduction processes in morphology processing.

In this way, by resizing an image to a smaller size once, the processing load of the superpixel processing can be reduced. However, if the image is resized to a too small size, the boundary accuracy deteriorates, so it is desirable to consider whether to perform resizing for each target object.

These configurations make it possible to balance the improvement of boundary accuracy using superpixels and the reduction of the load of segmentation work when segmenting images in annotation work.

### Second Embodiment

Next, a second embodiment of the present invention will be described.

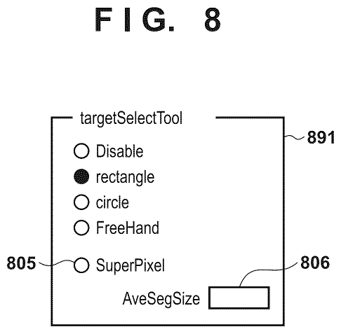

FIG. 8 is a diagram showing a part of a GUI of an application software in the second embodiment, showing “targetSelectTool” 891 displayed in place of “targetSelectTool” 691 in the GUI of the application software shown in FIG. 6. The rest of the configuration of the GUI of the application software is the same as that shown in FIG. 6. Further, the image processing system 100 in the second embodiment is the same as that shown in FIGS. 1 and 2, so the description thereof will be omitted.

In the second embodiment, as shown in “targetSelectTool” 891, “SuperPixel” 805 is provided as a target area designation method used in the condition determination unit 122 in addition to “Disable”, “rectangle”, “circle”, and “FreeHand”.

Next, the operation of the image processing system 100 in the second embodiment will be described with reference to FIG. 4, but only the processes that differs from the processes in the first embodiment will be described.

When “SuperPixel” 805 is selected in step S402 of FIG. 4, the condition determination unit 122 uses superpixels to specify the target object. Here, first, the input image is subjected to the superpixel processing using a first average segment size. The first average segment size is set using “AveSegSize” 806 of “SuperPixel” 805, and is a value larger than a second average segment size used in step S404 described later. Then, the target object is specified by selecting the superpixels of the target in the picture box 630 using the operation input unit 103.

By setting the first average segment size to a value larger than the second average segment size, the region of the target object can be roughly specified with coarse superpixels, reducing the workload, and by generating fine superpixels in step S404, high-precision processing can be achieved.

In addition, when the target object is specified by selecting large superpixels, the approximate shape of the target object can be known, so the value of the target division number set in step S401 may be corrected based on the complexity of the shape of the target object, as in the first embodiment. The complexity is calculated using curvature entropy, circularity, etc., and the larger this value is, the more the target division number value is corrected. In this way, by taking the shape of the target object into consideration, the segmentation accuracy of the superpixels can be improved.

As described above, according to the second embodiment, the approximate size of the region of the target object can be obtained with a smaller load, and the size can be obtained in a form that more closely reflects the shape of the object than using tools such as a rectangle or a circle. This makes it possible to realize superpixel processing with a more appropriate average segment size, and to further improve boundary accuracy.

### Third Embodiment

Next, a third embodiment of the present invention will be described.

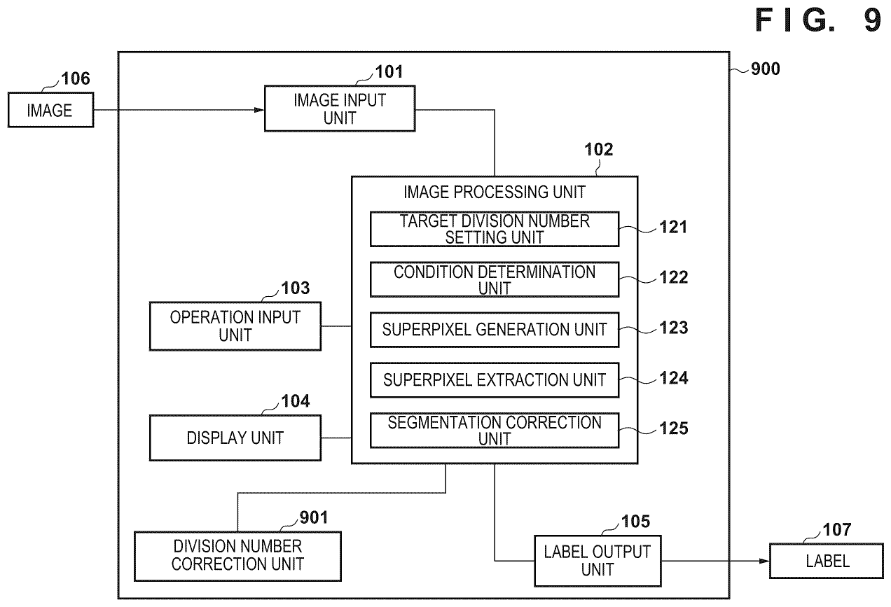

FIG. 9 is a block diagram showing a functional configuration of an image processing system 900 according to the third embodiment. As shown in FIG. 9, the third embodiment differs from the image processing system 100 according to the first embodiment shown in FIG. 1 in that a division number correction unit 901 is newly provided. The other configurations are the same as those described in the first embodiment, so the same reference numerals are given and the description thereof will be omitted.

The division number correction unit 901 has a function of correcting the average segment size of superpixels. Specifically, it takes statistics on the usage of the eraser tool “Eraser” 661 for each index (object), that is, the number of corrections, and generates a correction amount for the target division number specified in step S401 based on the statistics. Furthermore, it has a function of correcting the target division number “Nt” 692 based on the correction amount when the next superpixels of the same index (object) are generated. Here, “Eraser” 661 indicates labeling with the index value of the background.

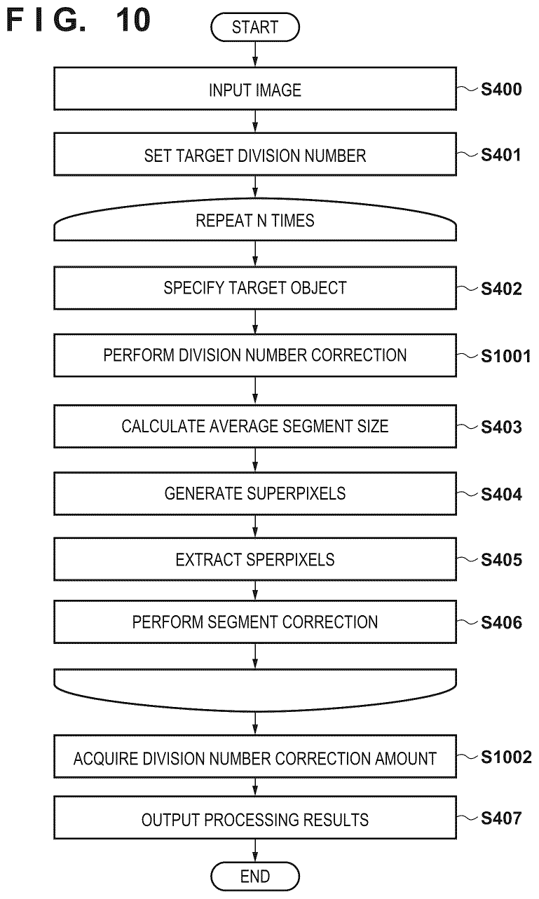

Next, the operation of the image processing system 900 in the third embodiment will be described with reference to the flowchart shown in FIG. 10. As shown in FIG. 10, the third embodiment differs from the first embodiment shown in FIG. 4 in that it newly performs a division number correction in step S1001 and a division number correction amount acquisition in step S1002. The other processes are the same as those shown in FIG. 4, so the same step numbers are given and explanation thereof will be omitted.

In the division number correction in step S1001, after the region of the target object is specified, the CPU 210 specifies the index of the object to which the region of the target object belongs, using the division number correction unit 901. The index is specified by the GUI of the application software (not shown). Then, if there is a division number correction amount to be acquired in step S1002 for the specified index, the target division number “Nt” 692 is corrected. The division number correction amount is calculated based on the usage statistics obtained by the segmentation correction unit 125. When the correction amount of index i is Hi, the target division number is corrected by multiplying the target division number “Nt” by Hi.

In step S1002, the division number correction amount is calculated based on the usage statistics obtained by the segmentation correction unit 125. Specifically, the CPU 210 uses the division number correction unit 901 to obtain statistics on the usage status of “Eraser” 661, and generates a correction amount for the target division number specified in step S401 for each index (object) based on the statistical values.

For example, if the average number of times the eraser tool is used per object for all indexes is Na, the average number of times the eraser tool is used per object for index i is Ni, and a coefficient for controlling the magnitude of the correction amount is k, then the correction amount Hi for index i may be calculated by Equation (1).

$$Hi = 1 + k ( Ni / Na - 1 ) \qquad ( 1 )$$

In this case, if the number of times the eraser tool is used for index i is average, that is, if Ni=Na, then Hi=1 and the target division number is not corrected. If the number of times the eraser tool is used for index i is higher than average, that is, if Ni>Na, then Hi becomes larger than 1, and the target division number “Nt” is corrected to a larger value, and the image segmentation becomes more accurate.

Conversely, if the number of times the eraser tool is used for index i is less than average, that is, if Ni<N, then Hi becomes smaller than 1, and the target division number “Nt” is corrected to a smaller value, and the load of image segmentation is reduced.

In addition, if Ni<Na, that is, if Hi is smaller than 1, in a case where the target division number “Nt” is corrected, the target division number will be corrected to a small value, and there is a concern that the image segmentation accuracy will drop. Therefore, if Ni<Na, correction may not be performed.

Note that, if an effective correction parameter is acquired, it is not necessary to acquire the division number correction amount in step S1002 and thereafter, and it is also possible to simply use the acquired correction parameter in step S1001.

As described above, according to the third embodiment, since it is considered that the segmentation accuracy is low for objects for which the eraser tool is used frequently, the target division number for the same object is corrected to be larger in the next segmentation. This enables segmentation with higher accuracy and makes it possible to reduce the number of times the eraser tool is used in the next segmentation.

### Fourth Embodiment

Next, a fourth embodiment of the present invention will be described.

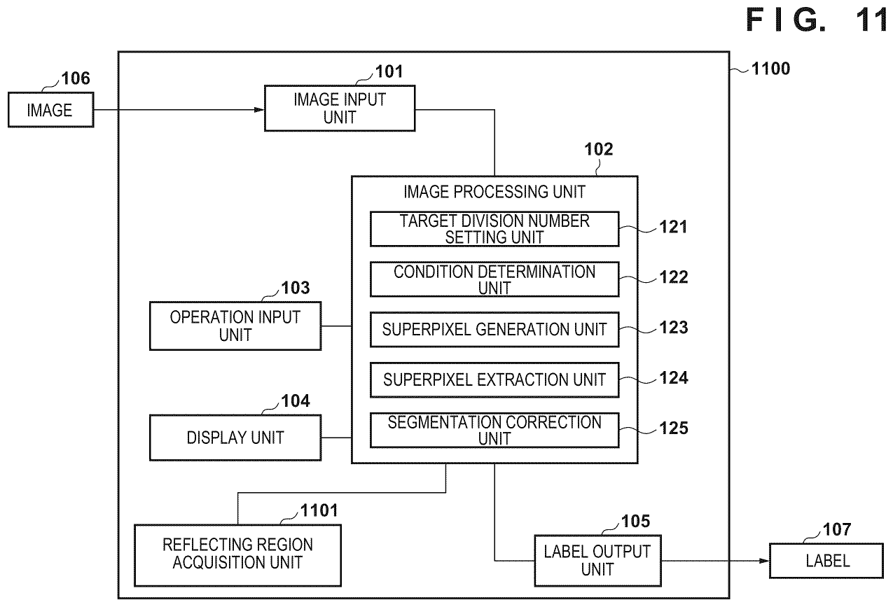

FIG. 11 is a block diagram showing a functional configuration of an image processing system 1100 according to the fourth embodiment. As shown in FIG. 11, the fourth embodiment differs from the first embodiment in that a reflecting region acquisition unit 1101 is newly provided in addition to the components of the image processing system 100 according to the first embodiment shown in FIG. 1. The other components are similar to those described in the first embodiment, so the same reference numerals are given and the description thereof will be omitted.

In the following explanation, it is assumed that the input image 106 is a dental image.

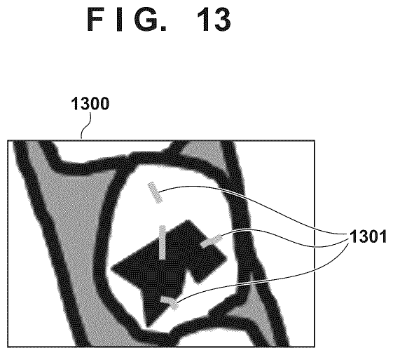

In dental images, specular reflection occurs due to saliva, and the color and texture of objects displayed in the intraoral photograph may appear different. FIG. 13 is an example of a partially enlarged view of the input image, showing an example where specular reflection portions 1301 are seen in the image. If any of the specular reflection portions 1301 is located on the boundary of the target object to be segmented, it may impair the accuracy of the segmentation.

The reflecting region acquisition unit 1101 acquires a specular reflection region contained in a dental image, and highlights the reflecting region in the picture box 630 displayed on the display unit 104.

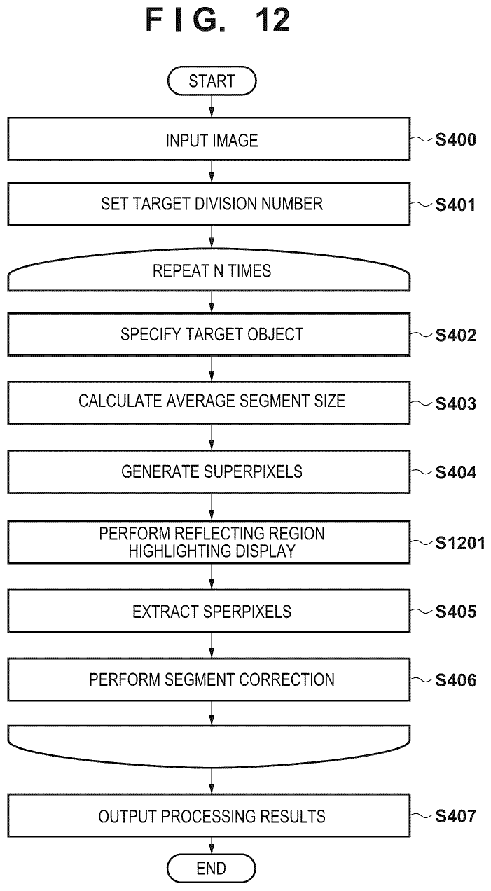

FIG. 12 is a flowchart showing the operation of the image processing system 1100 in the fourth embodiment. As shown in FIG. 12, in the fourth embodiment, in addition to the processing in the first embodiment shown in FIG. 4, a reflecting region highlighting display is newly performed in step S1201. Since the other processes are similar to the processes shown in FIG. 4, the same step numbers are given and the description thereof will be omitted.

In the reflecting region highlighting display in step S1201, a pixel having a luminance equal to or greater than a certain threshold in the image histogram is determined to belong to a reflecting region, and the reflecting region is superimposed and displayed on the image in the picture box 630 to highlight the reflecting regions. The reflecting region may be determined based on the RGB gradation values.

As described above, according to the fourth embodiment, even if there is reflection in an intraoral photograph, by highlighting the specular reflection region, superpixel extraction and segment correction in steps S405 and S406 can be performed while paying attention to the specular reflection region. This makes it possible to realize highly accurate segmentation.

### Other Embodiments

The present invention may be applied to a system made up of a plurality of devices, or to an apparatus made up of a single device.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An image processing apparatus comprising one or more processors and/or circuitry which function as:
an input unit that inputs image data of an image;
an acquisition unit that acquires a size of an object region including an object to be extracted that is included in the image;
a setting unit that sets a division number into which the object region is divided;
a determination unit that determines a segment size of a superpixel based on the size of the object region and the division number; and
a generation unit that generates, using the image data, superpixels each having a size in a predetermined range that includes the segment size determined by the determination unit.

2. The image processing apparatus according to claim 1, wherein the one or more processors and/or circuitry further functions as:
a selection unit that selects, from among the generated superpixels, superpixels corresponding to the object;
a correction unit that corrects a region formed by the selected superpixels so as to approximate a region of the object; and
an output unit that outputs a label that associates the corrected region formed by the superpixels with the object.

3. The image processing apparatus according to claim 2, wherein the setting unit, the selection unit, and the correction unit are configured with a GUI (Graphical User Interface) and an operation member.

4. The image processing apparatus according to claim 2, wherein the one or more processors and/or circuitry further functions as a reduction unit that reduces a size of the image,
wherein the generation unit, the selection unit, and the correction unit process the image reduced by the reduction unit, and the output unit resizes the corrected region formed by the superpixels to the size before reduction, and then outputs the label.

5. The image processing apparatus according to claim 4, wherein the output unit resizes the corrected region formed by the superpixels using a nearest neighbors method, performs a scaling process in a morphological process to correct the boundary of the resized region, and then outputs the label.

6. The image processing apparatus according to claim 1, wherein the generation unit generates the superpixels using any one of the algorithms: LS (Linear Spectral Clustering), SEEDS (Superpixels Extracted via Energy-Driven Sampling), and SLIC (Simple Linear Iterative Clustering).

7. The image processing apparatus according to claim 1, wherein the one or more processors and/or circuitry further functions as a designation unit that designates the object region,
wherein the designation unit designates the object region by using one or a combination of a unit that allows a user to designate the object region with a rectangle, a unit that allows the user to designate the object region with a circle, a unit that allows the user to designate the object region by freehand, or a unit that allows a user to select a rectangle from one of detection results of object detection, and
the acquisition unit acquires a size of the designated object region.

8. The image processing apparatus according to claim 7, wherein the designation unit is configured with a GUI (Graphical User Interface) and an operation member.

9. The image processing apparatus according to claim 7, wherein, in a case where the object region is designated by freehand by the designation unit, the setting unit sets a larger division number as a shape of the object region is more complicated.

10. The image processing apparatus according to claim 1, wherein the one or more processors and/or circuitry further functions as a designation unit that designates the object region by generating superpixels of a predetermined size using the image data and selecting superpixels corresponding to the object from among the generated superpixels,
wherein the predetermined size is greater than the segment size determined by the determination unit.

11. The image processing apparatus according to claim 10, wherein in the designation unit, a unit that selects the superpixels corresponding to the object is configured with a GUI (Graphical User Interface) and an operation member.

12. The image processing apparatus according to claim 10, wherein the setting unit sets a larger division number as the shape of the object region designated by the designation unit is more complicated.

13. The image processing apparatus according to claim 2, wherein the one or more processors and/or circuitry further functions as a division number correction unit that corrects the division number set by the setting unit,
wherein the division number correction unit corrects the division number according to an amount of correction by the correction unit, and
wherein the determination unit determines the segment size using the corrected division number in a case where the division number is corrected by the division number correction unit.

14. The image processing apparatus according to claim 13, wherein the division number correction unit increases the division number in a case where the amount of correction is greater than a predetermined threshold, and decreases the division number in a case where the amount of correction is less than a predetermined threshold.

15. The image processing apparatus according to claim 1, wherein the input image is a dental image.

16. The image processing apparatus according to claim 1, wherein the one or more processors and/or circuitry further functions as:
a judging unit that judges a pixel having a luminance equal to or greater than a predetermined threshold using the image data; and
a control unit that controls the image to be displayed on a display device,
wherein the control unit superimpose the pixel judged by the judging unit in an emphasized manner on the image displayed on the display device.

17. An image processing method comprising:
inputting image data of an image;
acquiring a size of an object region including an object to be extracted that is included in the image;
setting a division number into which the object region is divided;
determining a segment size of a superpixel based on the size of the object region and the division number; and
generating, using the image data, superpixels each having a size in a predetermined range that includes the determined segment size.

18. A non-transitory computer-readable storage medium, the storage medium storing a program that is executable by the computer, wherein the program includes program code for causing the computer to function as an image processing apparatus comprising:
an input unit that inputs image data of an image;
an acquisition unit that acquires a size of an object region including an object to be extracted that is included in the image;
a setting unit that sets a division number into which the object region is divided;
a determination unit that determines a segment size of a superpixel based on the size of the object region and the division number; and
a generation unit that generates, using the image data, superpixels each having a size in a predetermined range that includes the segment size determined by the determination unit.
